(19) United States
(12) Patent Application Publication
(10) Pub. No.: US 2024/0291629 A1
(43) Pub. Date: Aug. 29, 2024

(54) SYSTEMS, APPARATUS, AND METHODS FOR DYNAMIC CELL STATE MANAGEMENT FOR ENERGY SAVING

(71) Applicant: AirHop Communications, Inc., San Diego, CA (US)

(72) Inventors: Peyman Tehrani, Irvine, CA (US); Bijan Golkar, San Diego, CA (US)

(73) Assignee: AirHop Communications, Inc., San Diego, CA (US)

(21) Appl. No.: 18/587,663

(22) Filed: Feb. 26, 2024

Related U.S. Application Data
(60) Provisional application No. 63/486,987, filed on Feb. 26, 2023.

(51) Int. Cl. H04L 5/00

(52) U.S. Cl. CPC H04L 5/0098; H04L 5/001; H04L 5/006

(57) ABSTRACT

Systems, apparatus, and methods for controlling cell activation state. Cellular service providers (CSPs) experience fluctuating levels of demand throughout the day and across different segments (business, consumers). While CSPs can augment their cellular coverage carriers with additional capacity carriers, doing so comes with increased energy and cost. Ideally, CSPs would like to dynamically adapt capacity to accommodate the service demand. Various embodiments of the present disclosure enable an energy savings rApp (non-real-time remote application) that leverages AI base learning and RAN programmability to predict increased traffic. By enabling RAN pre-emptively, the cellular network can ensure user quality of service (QOS) while still minimizing energy consumption.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of cellular network management. Specifically, the present disclosure is directed to hardware, software, and/or firmware implementations for controlling cell activation state.

### DESCRIPTION OF RELATED TECHNOLOGY

Historically, cellular networks provided coverage according to static network planning. More recently, the cellular networks are designed to provide several “layers” of coverage and capacity that work together to provide a seamless and high-quality wireless experience.

Dynamic cell coordination is a non-trivial task with significant costs and benefits. Machine learning algorithms are among the proposed techniques for optimizing cellular network operation.

### BRIEF DESCRIPTION OF THE DRAWINGS

FIG. 1 is a logical block diagram of a homogenous wireless network architecture useful to explain various aspects of the present disclosure.

FIG. 2 is a logical block diagram of an exemplary heterogenous wireless network architecture useful to explain various aspects of the present disclosure.

FIG. 3 is a logical block diagram of one exemplary system configured to dynamically manage cell state for a radio access network (RAN).

FIG. 4 is a logical block diagram of one machine learning system useful in conjunction with the various aspects of the present disclosure.

FIG. 5 is a table of parameters and associated equations, useful in conjunction with the various aspects of the present disclosure.

FIG. 6 is a graphical plot of power, accessibility, and reward; based on the parameters of FIG. 5.

FIG. 7 illustrates one exemplary model inference and online training mechanism.

FIGS. 8A-8B are graphical representations of an exemplary system and dynamic cell state management useful to explain various aspects of the present disclosure.

FIG. 9 is a graphical representation of energy saving operation, in accordance with one specific implementation of the present disclosure.

FIG. 10 is a graphical comparison of two different deep reinforcement learning agents, useful to explain various aspects of the present disclosure.

FIG. 11 provides a direct comparison of operational modes, useful to explain various aspects of the present disclosure.

FIG. 12 is a logical block diagram of one generalized network architecture, useful in accordance with the various principles described herein.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description.

Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### Network Planning Challenges of 5G Networks

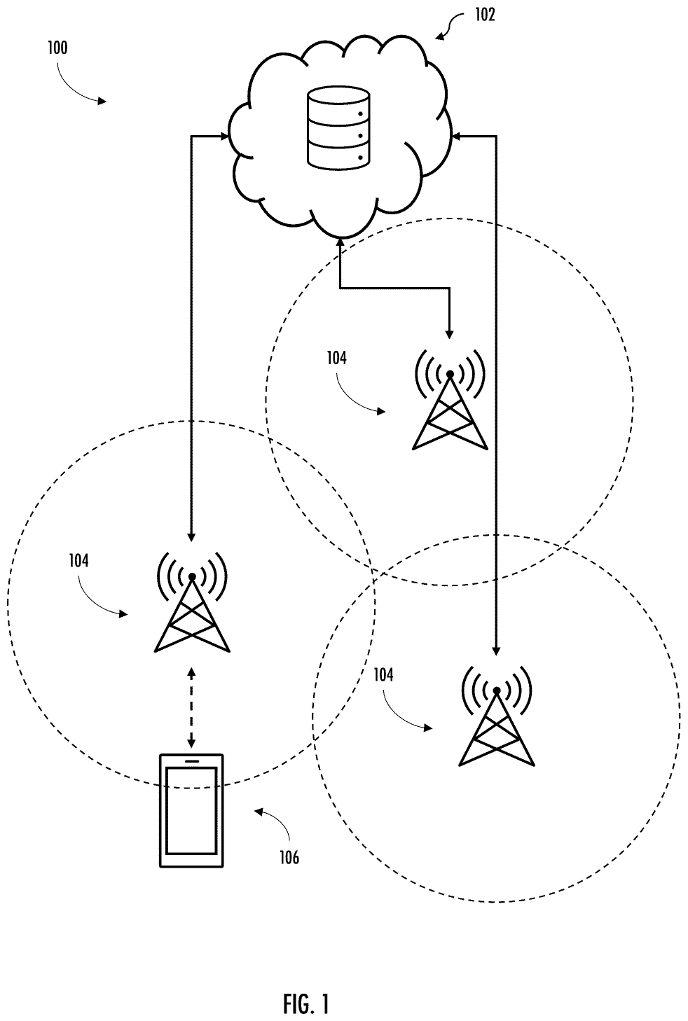

Cellular networks have been historically designed around homogenous networking assumptions. FIG. 1 is a logical block diagram of a homogenous wireless network architecture 100 useful to explain various aspects of the present disclosure. As shown, the cellular network includes a network operator's compute resources 102 that manage a Radio Access Network (RAN) composed of several base stations 104 that provide coverage to user equipment 106.

More recent 4G cellular networking technologies (e.g., LTE, LTE-A) support heterogenous networking with a combination of macro, outdoor, indoor enterprise and residential small cells deployed on multiple frequency layers. One of the major problems in the network operation is energy consumption which plays a very significant role in the operations expenditure (OPEX) and in turn increases the Total Cost of Ownership (TCO).

Further improving on 4G cellular networking technologies, 5G supports a larger variety of applications, each with different usage requirements. Notably, such applications span ultra-low power applications (e.g., Internet-of-Things (IoT)), high-throughput applications (Enhanced Mobile Broadband (eMBB)), low-latency applications (Ultra Reliable Low Latency Communications (URLLC)), and/or machine-only applications (Massive Machine Type Communications (mMTC)). So-called “Low-band 5G” is designed to provide 30-250 megabits per second (Mbit/s) as a coverage frequency layer (600-850 MHz). So-called “Mid-band 5G” may provide 100-900 Mbit/s as a capacity frequency layer (2.5-3.7 GHZ); Unlike 4G, 5G supports milli-meter wave (mmWave) bands (“High-band 5G”) which may offer extraordinarily fast data rates (multiple Gigabit/s (Gbit/s)) over very short distances that would serve as additional capacity layers where required. The problem of energy consumption and its associated costs are even more critical as the 5G base stations have proven to be extremely power hungry, particularly in higher frequency bands.

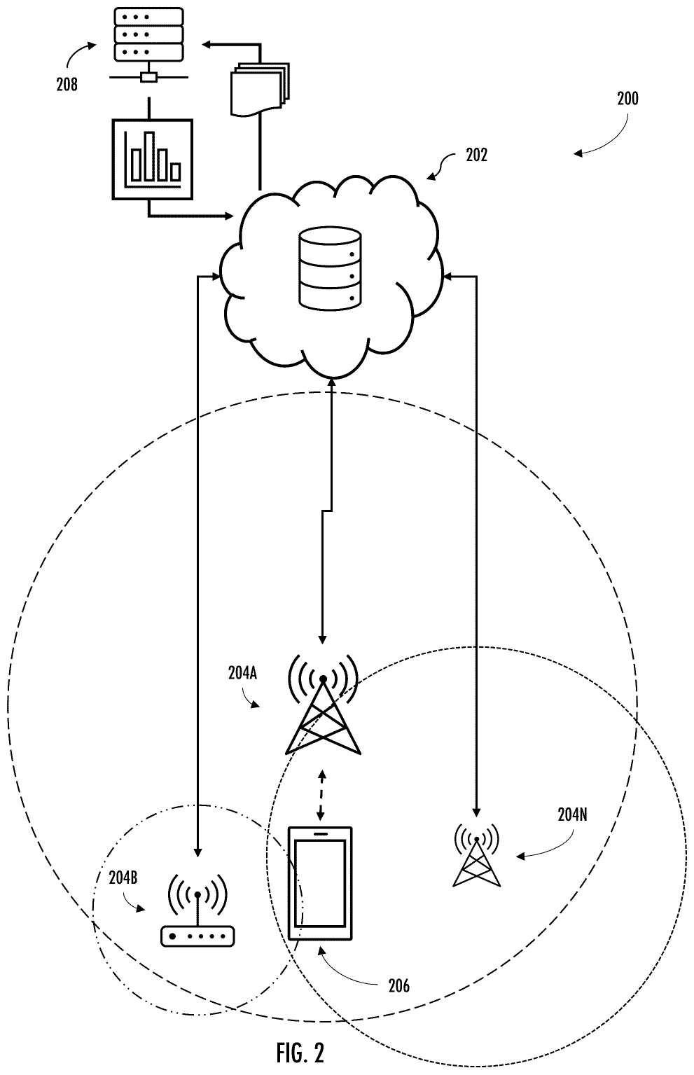

FIG. 2 is a logical block diagram of an exemplary heterogenous wireless network architecture 200 useful to explain various aspects of the present disclosure. As shown, the cellular network includes a network operator's compute resources 202 that manage a diverse set of access nodes 204A, 204B . . . 204N to provide coverage and capacity to the end-users 206. Notably, the deployment of access nodes 204A, 204B . . . 204N may be arbitrary and highly fluid. In order to reduce energy consumption, the access nodes will need to switch to “sleep mode” when not in use thus dynamically adjusting and adapting their energy consumption with the varying network traffic demand.

In view of the complex requirements of modern cellular networks, it may not be feasible for a network operator to statically plan for (or manage on a day-to-day basis) the variety of different equipment that is necessary to provide comprehensive service. So-called “Self-Organizing Network” (SON) technology enables mature 4G and 5G operation.

Airhop Communications, Inc. has developed several SON network management suites that allow network operators to externalize real-time network optimizations to 3^{rd} party servers (also referred to as network virtualization). The virtualized network paradigm facilitates the dynamic adjustment of networks for specific users and may adapt networks based on traffic conditions. For example, as shown in FIG. 2, a network operator can offload network statistics and data to an external server 208. The external server 208 can provide e.g., diagnosis, self-optimization and/or self-healing data and/or instructions back to the network operator's compute resources 202 for use.

The aforementioned energy consumption problem has been formally documented in the 3GPP Technical Report 37.817 entitled 3^{rd} Generation Partnership Project; Technical Specification Group Radio Access Network; Evolved Universal Terrestrial Radio Access (E-UTRA) and NR; Study on enhancement for Data Collection for NR and EN-DC, Release 17, published Apr. 6, 2022, incorporated herein by reference in its entirety. As discussed therein, TR 37.817 leaves an open question as to the viability of machine learning (ML) techniques to minimize energy consumption. Quoted excerpts follow:
“To meet the 5G network requirements of key performance and the demands of the unprecedented growth of the mobile subscribers, millions of base stations (BSs) are being deployed. Such rapid growth brings the issues of high energy consumption, CO₂ emissions and operation expenditures (OPEX). Therefore, energy saving is an important use case which may involve different layers of the network, with mechanisms operating at different time scales.
Cell activation/deactivation is an energy saving scheme in the spatial domain that exploits traffic offloading in a layered structure to reduce the energy consumption of the whole radio access network (RAN). When the expected traffic volume is lower than a fixed threshold, the cells may be switched off, and the served UEs may be offloaded to a new target cell.
Efficient energy consumption can also be achieved by other means such as reduction of load, coverage modification, or other RAN configuration adjustments. The optimal energy saving decision depends on many factors including the load situation at different RAN nodes, RAN nodes capabilities, KPI/QOS requirements, number of active UEs and UE mobility, cell utilization, etc.
However, the identification of actions aimed at energy efficiency improvements is not a trivial task. Wrong switch-off of the cells may seriously deteriorate the network performance since the remaining active cells need to serve the additional traffic. Wrong traffic offload actions may lead to a deterioration of energy efficiency instead of an improvement. The current energy-saving schemes are vulnerable to potential issues listed as follows:
   Inaccurate cell load prediction. Currently, energy-saving decisions rely on current traffic load without considering future traffic load.
   Conflicting targets between system performance and energy efficiency. Maximizing the system's key performance indicator (KPI) is usually done at the expense of energy efficiency. Similarly, the most energy efficient solution may impact system performance. Thus, there is a need to balance and manage the trade-off between the two.
   Conventional energy-saving related parameters adjustment. Energy-saving related parameters configuration is set by traditional operation, e.g., based on different thresholds of cell load for cell switch on/off which is somewhat a rigid mechanism since it is difficult to set a reasonable threshold.
   Actions that may produce a local (e.g., limited to a single RAN node) improvement of Energy Efficiency, while producing an overall (e.g., involving multiple RAN nodes) deterioration of Energy Efficiency.
To deal with issues listed above, ML techniques could be utilized to optimize the energy saving decisions by leveraging on the data collected in the RAN network. ML algorithms may predict the energy efficiency and load state of the next period, which can be used to make better decisions on cell activation/deactivation for energy saving. Based on the predicted load, the system may dynamically configure the energy-saving strategy (e.g., the switch-off timing and granularity, offloading actions) to keep a balance between system performance and energy efficiency and to reduce the energy consumption.”

More generally, cellular service providers (CSPs) experience fluctuating levels of demand throughout the day, and across different customer segments (business, residential). While CSPs can augment their cellular coverage carriers with additional capacity carriers, doing so comes with increased energy and cost. Ideally, CSPs would like to dynamically adapt capacity to accommodate increases in service demand while also minimizing energy consumption during lulls.

### Exemplary Machine-Learning Implementation

Exemplary embodiments of the present disclosure enable an energy savings rApp (non-real-time application) that leverages artificial intelligence (AI) base learning and radio access network (RAN) programmability to predict traffic demand. By pre-emptively enabling/disabling capacity based on predicted traffic, the cellular network can ensure user quality of service (QOS) while still minimizing energy consumption.

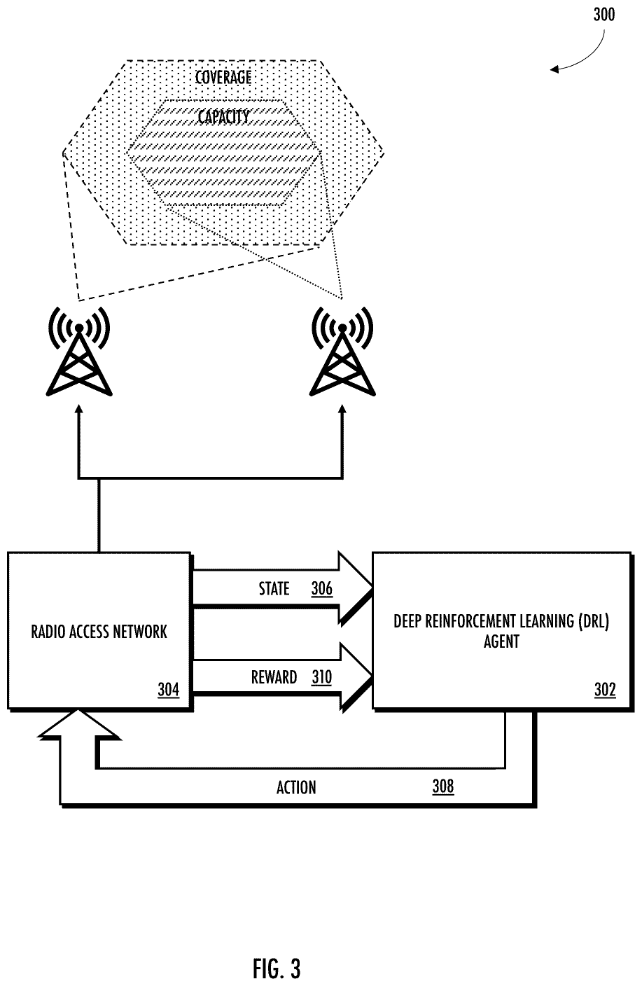

FIG. 3 illustrates a logical block diagram of one exemplary system 300 configured to dynamically manage the energy consumption of a radio access network (RAN). As shown, a cell may have multiple carrier frequencies; here, a “coverage” carrier provides a broad area of robust coverage while a “capacity” carrier provides a smaller area of high performance to accommodate increases in demand. During certain times of the day, demand may be low (trough) and the coverage carrier may be sufficient to satisfy the client demands. However, during high (peak) usage, the capacity carrier(s) may be necessary to ensure adequate quality-of-service (QOS). Ideally, the RAN should turn off the capacity cells when there is low traffic demand and turn on the capacity cells when the traffic demand is high.

In one exemplary embodiment, a deep reinforcement learning agent (DRL agent 302) obtains state information 306 from one or more cells of a RAN 304. Based on its inferences, the DRL agent 302 generates an action 308 that dynamically sets the cell activation/deactivation threshold and in turn would either change the cell state to energy savings mode with no traffic demand or switch the cell to active mode to offer additional capacity should it be required. The resulting performance metrics and energy consumption are collected by the RAN 304 and provided as feedback (reward 310) to the DRL agent 302.

In one specific implementation, the DRL agent 302 attempts to balance power consumption against quality-of-service (QOS) or other user satisfaction metrics. In some cases, the DRL agent may additionally include hysteresis considerations to prevent excessive on-off transitions. Other implementations may consider model complexity (e.g., the amount of training data, memory space, execution time, etc.). More generally, any number of different costs and/or optimizations may be considered. For example, some implementations may consider profit and/or cost, number of users, the availability and/or absence of other network providers, and/or any number of considerations.

As a brief aside, deep reinforcement learning (DRL) is a subfield of machine-learning that combines reinforcement learning (RL) with deep learning. Here, RL refers to machine-learning techniques that train a computational agent to explore a manually created finite set of states, through a process of trial-and-error (typically modeled as a Markov decision process). In contrast, DRL techniques incorporate deep learning solutions to explore unstructured data (without a curated state space). Most DRL solutions transform a set of inputs into a set of outputs via a neural network.

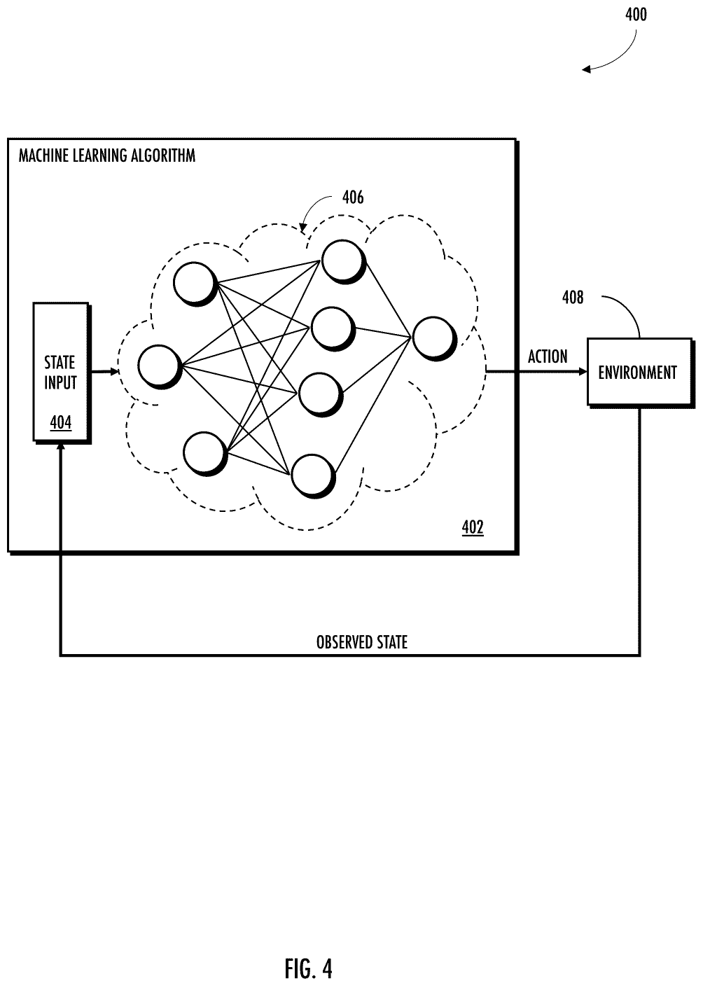

FIG. 4 is a logical block diagram of one neural network system 400 useful in conjunction with the various aspects of the present disclosure. A machine learning algorithm 402 obtains state input 404 and processes the state input 404 with a neural network of processor nodes 406. The neural network of processor nodes 406 generate an action that affects the environment 408. The environment 408 is then observed to provide the next state input. Each processor node of the neural network of processor nodes 406 is a computation unit that may have any number of weighted input connections, and any number of weighted output connections. The inputs to a processor node are combined according to a transfer function to generate the outputs. In one specific embodiment, each processor node of the neural network of processor nodes 406 combines its inputs with a set of coefficients (weights) that amplify or dampen the constituent components of its input data. The input-weight products are summed and then the sum is passed through a node's activation function, to determine the size and magnitude of the output data. “Activated” neurons (processor nodes) generate output data. The output data may be fed to another neuron (processor node) or result in an action on the environment 408. Coefficients may be iteratively updated with feedback to amplify inputs that are beneficial, while dampening the inputs that are not.

In one embodiment, the machine learning algorithm 402 emulates the processing of each processor node of the neural network of processor nodes 406 as an independent thread. A “thread” is the smallest discrete unit of processor utilization that may be scheduled for a core to execute. A thread is characterized by: (i) a set of instructions that is executed by a processor, (ii) a program counter that identifies the current point of execution for the thread, (iii) a stack data structure that temporarily stores thread data, and (iv) registers for storing arguments of opcode execution. Other implementations may use hardware or dedicated logic to implement processor node logic.

As used herein, the term “emulate” and its linguistic derivatives refers to software processes that reproduce the function of an entity based on a processing description. For example, a processor node of a machine learning algorithm may be emulated with “state inputs,” and a “transfer function,” that generate an “action.”

Conceptually, machine learning algorithms learn a task that is not explicitly described with instructions. In other words, machine learning algorithms seek to create inferences from patterns in data using e.g., statistical models and/or analysis. The inferences may then be used to formulate predicted outputs that can be compared to actual output to generate feedback. Each iteration of inference and feedback is used to improve the underlying statistical models. Since the task is accomplished through dynamic coefficient weighting rather than explicit instructions, machine learning algorithms can change their behavior over time to e.g., improve performance, change tasks, etc.

Typically, machine learning algorithms are “trained” until the desirable performance is attained. Training may occur “offline” on a digital twin of the real network before deployment and “online” with live data once the algorithm is deployed on the target network. Many implementations combine offline and online training to e.g., provide accurate initial performance that adjusts to system-specific considerations over time.

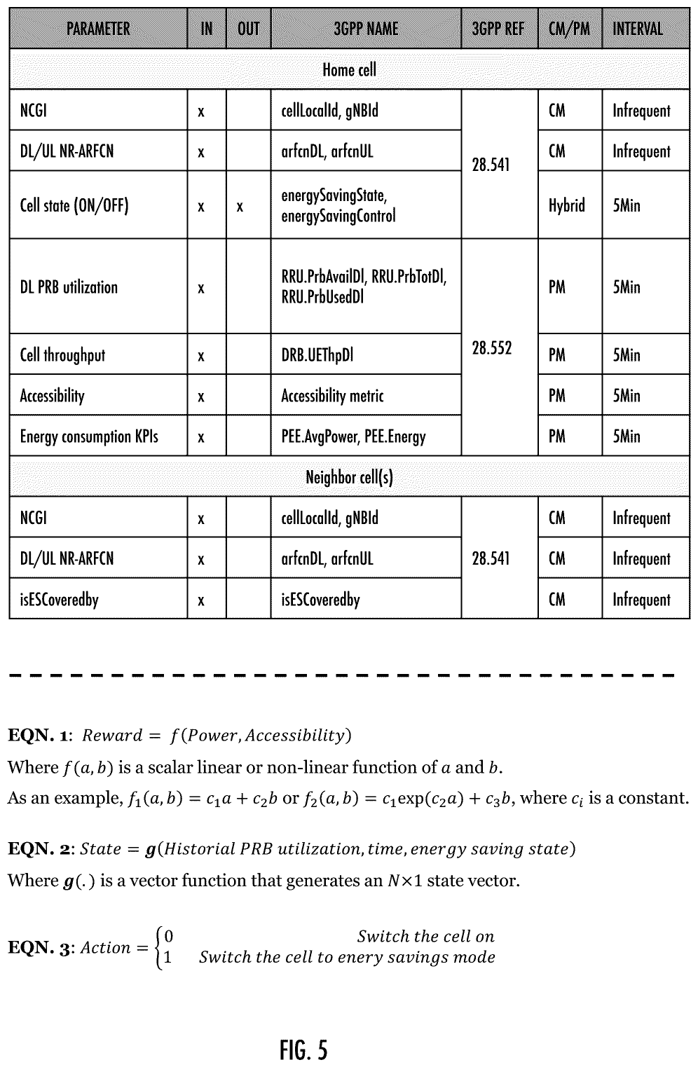

While the 3GPP has suggested that machine learning techniques may have promise in improving the energy consumption of the cellular networks, the 3GPP has not promulgated any specific implementation. Techniques of the present disclosure provide a solution to this long felt need. FIG. 5 is a table that provides a novel and unique set of parameters that define the state 306, action 308, and reward 310 which are obtained via various entities of the system (e.g., Central Units (CUs), Distributed Units (DUs) and User Equipment (UEs)).

As shown therein, the term “parameter” refers to a data structure or a set of data structures used by the exemplary machine learning algorithm. Input parameters are used directly, or indirectly (a mathematical derivation, etc.), to generate the state vector 306. Output parameters are used directly, or indirectly, to generate the action 308. The various parameters may reflect a configuration (configuration management (CM)), a performance (performance management (PM)), or both. The reward 310 is generated based on the CM, PM and/or hybrid parameters. Where possible, the parameters are based on existing metrics that are already collected by the various distinct entities of the RAN (e.g., 3GPP Technical Specification 28.541 entitled 3^{rd} Generation Partnership Project; Technical Specification Group Services and System Aspects; Management and orchestration; 5G Network Resource Model (NRM); Stage 2 and stage 3, Release 18, published Feb. 8, 2023, and 3GPP Technical Specification 28.552 3^{rd} Generation Partnership Project; Technical Specification Group Services and System Aspects; Management and orchestration; 5G performance measurements, Release 18, published Jan. 6, 2023, each of which is incorporated herein by reference in its entirety). Notably, the access nodes of the RAN do not have visibility into one another and cannot analyze these parameters for energy saving operation. As discussed in greater detail below, the O1 interface provides RAN visibility to 3^{rd} party applications, which provide management and orchestration functions.

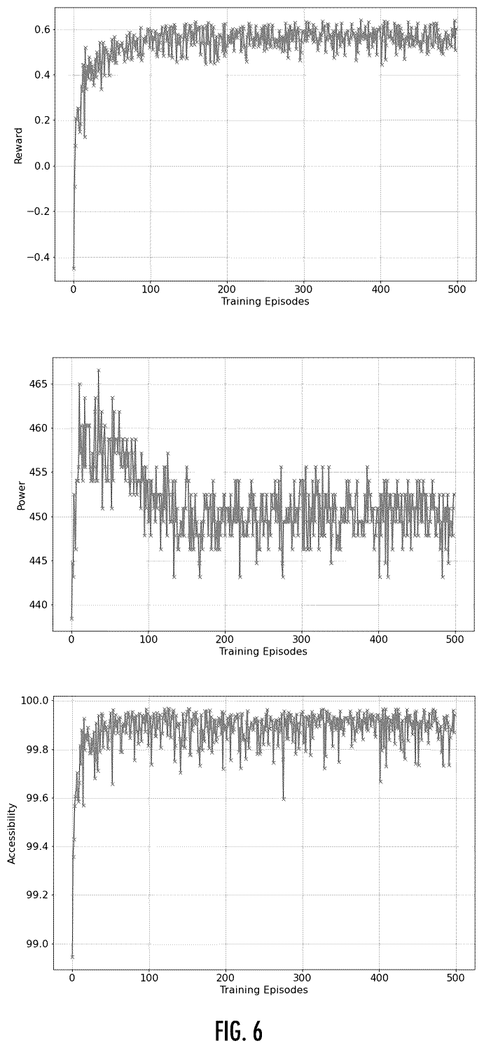

In one exemplary embodiment, the various parameters are combined according to EQNS. 1-3 (as described in FIG. 5 and plotted within FIG. 6). While the foregoing is presented in the context of a specific combination of parameters, artisans of ordinary skill in the related arts will readily appreciate that a variety of other combinations may be substituted with equal success. More broadly, the “state” of the cellular network is quantified (or otherwise mathematically described) based on the radio frequency (RF) environment; the “reward” of the cellular network is quantified (or otherwise mathematically described) based on energy consumption and performance/accessibility, and the action dynamically sets the thresholds for turning cells on and off.

More generally, a variety of different ML-based approaches may be used to dynamically control cell states. Conceptually, predictive modeling uses offline data and supervised learning to train the neural network to predict a future traffic load, based on current traffic load measurements. In some implementations, the prediction could be a binary classification; e.g., determining whether a future traffic load will be above or below a threshold level. In other implementations, the prediction could be a regression; e.g., estimating a future physical resource block utilization based on a current physical resource block utilization.

Even though, many different factors can affect cell performance, empirical evidence suggests that most traffic tends towards patterns that are cell-specific. Conceptually, this is because many of the most salient factors for traffic are strongly correlated with geography (e.g., interfering structures, daily user commutes, etc.). Thus, some embodiments of the present disclosure may use a cell-specific model that is trained with data obtained from a specific cell, so that the model may learn the specific characteristics of that cell. Separately, machine-learning techniques often greatly improve from the breadth and variety of training data. Thus, some embodiments of the present disclosure may use a single model that is trained with data obtained from many different cells, so as to broadly generalize across a variety of different scenarios. More generally, the techniques may be extended to use a spectrum of network-wide and cell-specific training data to yield both robust generalized behaviors for unknown data, as well as cell-specific tailoring for frequently observed data traffic.

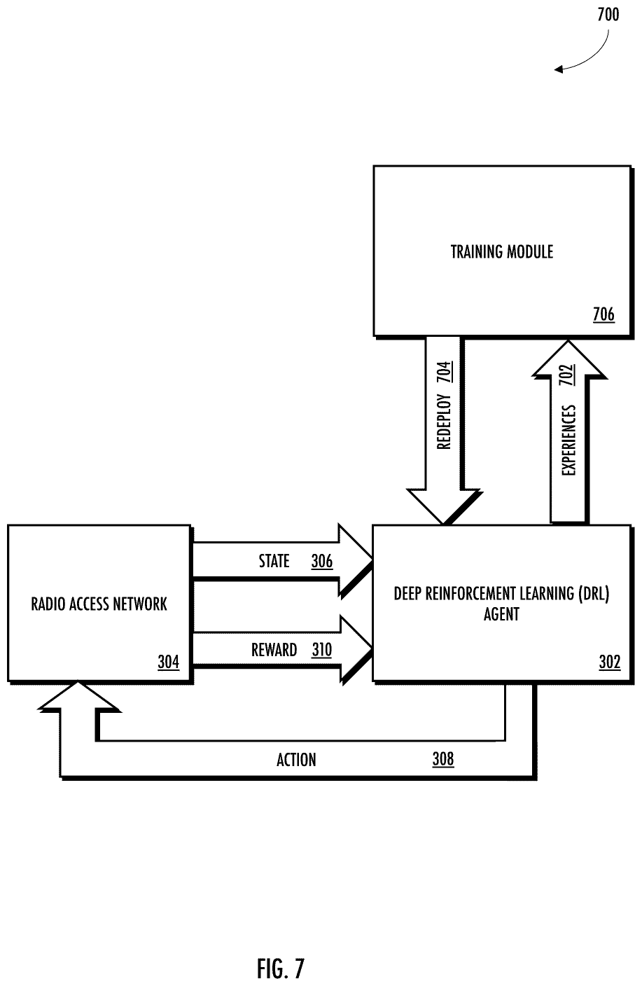

As a related note, DRL performance is often improved by online simulator training. FIG. 7 illustrates one exemplary model inference and training mechanism 700. Initially, the model is trained offline where the Radio Access Network 304 is simulated (often referred to as a digital twin of the target RAN). In this phase, the deep reinforcement learning agent (DRL agent 302) monitors and collects state 306 and reward 310 data and produces action 308 (collectively referred to as “experiences 702”). The experiences are used to train the DRL agent. The DRL agent “learns” by exploring the action space (making mistakes) and exploiting what it learns. It is important to note that the success of a Machine Learning (ML) model is directly proportional to the quality of the training data. The model formulates its understanding from the patterns it recognizes during training, enabling it to make similar decisions in analogous situations. While a well-trained ML model may exhibit good performance on yet unseen random realizations of the same digital twin network, its real-world performance is only as good as the digital twin RAN's simulated conditions of the target deployment environment. Once deployed, the digital twin is replaced with the target actual network 304 where the model is periodically fine-tuned, e.g., re-trained, to adapt to the actual RF environment, traffic pattern, and energy consumption conditions.

In some cases, a digital twin cannot be used for training. As but one such example, a new cell deployment may not have enough (or any) historic data to create a representative digital twin. In these cases, the machine-learning model may be trained using supervised learning techniques-importantly, however, supervised training data is manually curated and may implicitly reinforce unintended behaviors. In other words, there are several common pitfalls for training a supervised ML model. For example, a supervised learning model may only optimize for prediction error; e.g., the model might only consider power consumption and ignore accessibility. As another example, a supervised learning model may not correctly account for its penalties and/or other real-world effects. For instance, turning off a capacity cell might have repercussions that are different than turning on a capacity cell. One solution might be to use asymmetric penalties—e.g., missed accessibility may be weighted more strongly, etc. Still another example may be incorrect quantization of input/output. For example, when the estimated future traffic load is larger than 1 (100%), the model may incorrectly estimate values that are close to, but not exceeding 1 (e.g., 99%). This would result in a missed activation opportunity. One solution might be to lower the threshold value for cell activation; this would improve accessibility for only a marginally lower power savings.

Moreover, limitations on the quantity and/or quality of training data may introduce overfitting issues. Overfitting occurs where the model learns behaviors that are accurate for the training set but are incorrect for non-training data. Conceptually, the addition of noise or other sources of uncertainty ensures that the model learns to correctly discriminate between information and noise. In some cases, uncertainty may be quantified/qualified with bounding information. For example, upper bounds and lower bounds may provide some measure of “confidence”-larger differences in the upper and lower bounds conveys larger uncertainty and vice versa. In some cases, these confidence intervals may be used to tweak behavior to be more radical/conservative.

Exemplary embodiments may further incorporate “uncertainty-aware” machine-learning models and techniques that consider uncertainty when determining thresholds to avoid overfitting. In other words, uncertainty is added to avoid overfitting due to the quantity/quality of the training data (data dependent) and/or cell-specific considerations (cell dependent). Model ensemble and quantile regression are two uncertainty-aware approaches for predicting quality-of-service (QOS) degradation.

So-called “model ensemble” implementations use multiple machine-learning models with different training to perform predictions. For example, a model ensemble might use multiple models that are each trained to predict traffic for different time increments (e.g., next 5 minutes, next 10 minutes, next 15 minutes, etc.). The results of the model ensemble is used to identify the upper and lower bounds for the next time interval (e.g., hour of traffic, etc.). As another such example, a model ensemble might use multiple models that are each trained with different techniques (e.g., SAC, TD3, etc.). Still other model ensembles might use different amounts of training data. In other words, a model ensemble might combine predictions from a diverse set of models to provide upper and lower bounds or other statistical information.

So-called “quantile regression” implementations may attempt to estimate the quantiles of a dependent variable based on the values of an independent variable. Here, a quantile refers to a portion of the statistical distribution (e.g., τ=0.5 corresponds to the median (50th percentile), τ=0.1 corresponds to the tenth percentile, etc.). Quantile regression allows for asymmetric penalties; this can be used to penalize over-prediction more or less heavily than under-prediction. For example, a quantile loss for an individual data point might be given by EQN. 4:

$${L}_{τ} ( y , \hat{y} ) = \{ \begin{matrix}τ ( y - \hat{y} , & if y \geq \hat{y} \\ ( 1 - τ ) ( \hat{y} - y ) , & if y > \hat{y}\end{matrix} \qquad EQN 4$$

Where:
y is the true value
ŷ is the predicted value; and
τ is the desired quantile.
   Conceptually, models with larger t will estimate an upper bound of the load, leading to more conservative models. Smaller t will estimate a lower bound of the load, leading to more aggressive models. More generally, a variety of different techniques may be substituted with equal success to achieve different desired outcomes (e.g., power savings, cost savings, performance, etc.

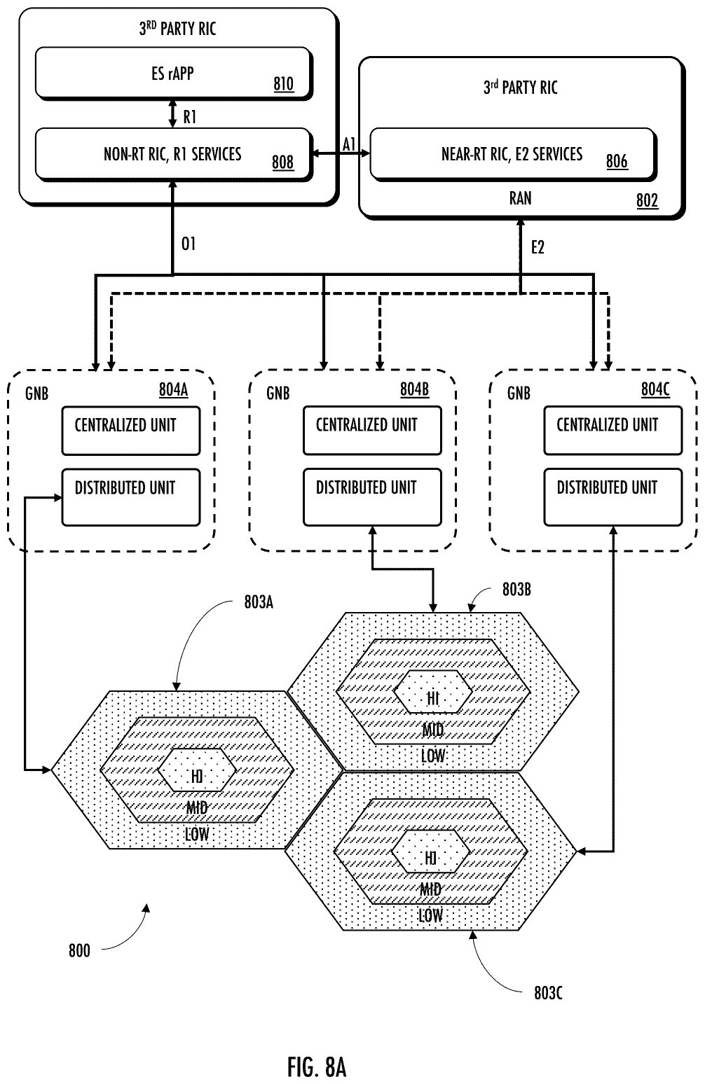

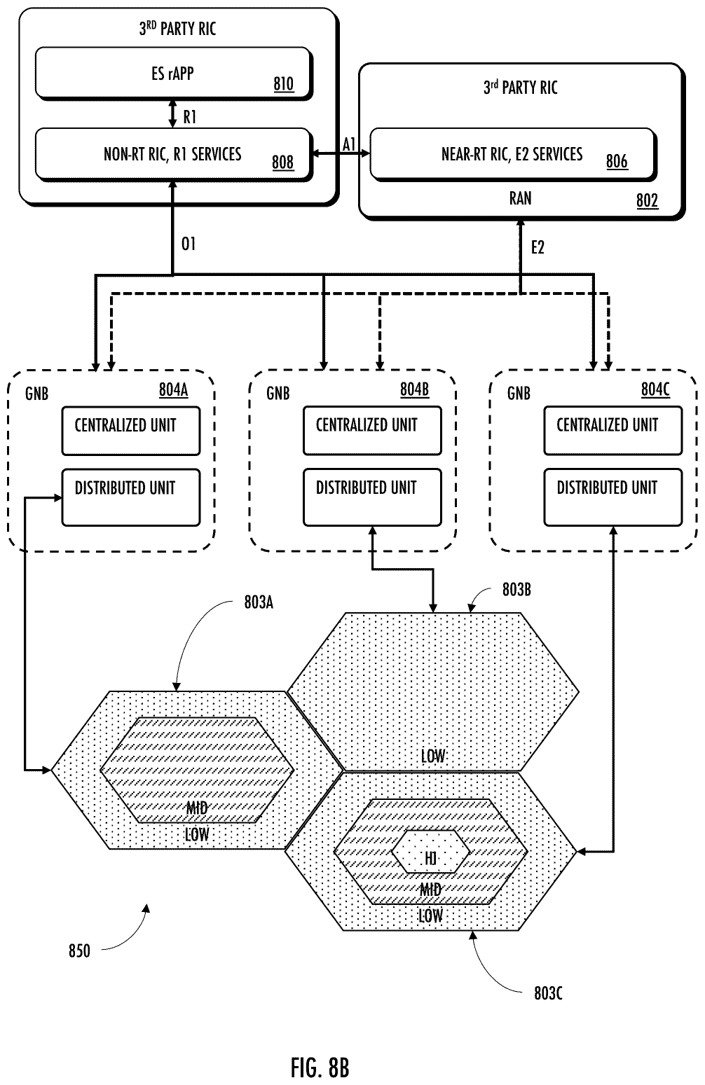

FIG. 8A is a graphical representation of an exemplary system and first scenario 800, useful to illustrate the dynamic energy savings operation. The base stations (804A, 804B, 804C) provide coverage and capacity to user equipment. In the exemplary system, each base station may be logically subdivided into a centralized unit (CU) and one or more distributed units (DUs) which may control multiple radio units (RUS). Each DU of the serving cell includes a multi-layered footprint (803A, 803B, 803C). As shown in FIG. 8A, each serving cell provides low-band coverage, and a mid-band and a high-band for additional capacity.

In one embodiment, the serving cell aggregates the UE measurements and/or other base station information. In some cases, the serving cell may collect UE measurements from various entities of the networking stack; for example, the CU may provide RRC connection data, the DU may provide MAC data, and the RU may provide RF data, etc. Examples of UE report data may include, without limitation, real-time UE measurement reports, serving/neighbor cell signal strength, channel quality index (CQI), and/or raw UE throughput. In some variants, the real-time data from other base stations may also be aggregated. Examples may include UE reports for its (the other base station's) connected UEs and/or any other resource allocation/utilization information. Some variants may use time windowing to “batch” relevant metrics within the same interval window; other variants may stream metrics continuously.

In one exemplary embodiment, the Energy Savings (ES) rApp 810 uses the aggregated UE measurements and/or other base station information (collectively “aggregated information”) as its state input. The ES rApp 810 is trained (either offline and/or online) to generate output actions for cell state thresholds. The output actions (cell state thresholds) determine potential changes in the cell states which in turn are communicated to the respective base stations (804A, 804B, 804C).

Once the base stations (804A, 804B, 804C) receive the updated cell activation/deactivation commands, the base stations accordingly adjust their layers which results in changes to the network performance metrics. More directly, the machine learning logic activates/deactivates the capacity layer cells (mid-band and/or high-band); coverage layers may be retained to critical service functionality (e.g., initial search, registration, paging, etc.). For example, base station 804A may be instructed to “sleep” its high-band layer, base station 804B may be instructed to “sleep” all capacity layers, and base station 804C may remain “as-is.” Any observed changes are measured and reported (e.g. UE measurement reports). The UE measurement reports for the connected UEs can be returned as the observed state and reward for the next iteration of machine learning processing.

In the illustrated embodiment, the ES rApp 810 is implemented via external servers; in other implementations (not shown), the machine learning logic may be geographically localized or even cell-specific. Additionally, while the illustrated ES rApp 810 is depicted as a single server, the functionality may be distributed across multiple servers with equal success. In some such variants, the servers may be organized according to e.g., geographic region, cell-specific allocations, functional allocations, or any other network organization.

As shown in FIGS. 8A and 8B, various aspects of the present disclosure measure cellular performance (e.g. accessibility) via UE reports and adjust cell layers to minimize unnecessary power consumption. The foregoing exemplary scenarios demonstrate trade-offs between coverage area, accessibility, and power consumption. More generally however, the concepts described herein may be broadly extended to any network that would benefit from dynamic management of cell state. For example, the techniques described herein may be used to reduce network capacity, improve network reliability/performance, minimize operational costs, and/or maximize operating profits.

### Empirical Results

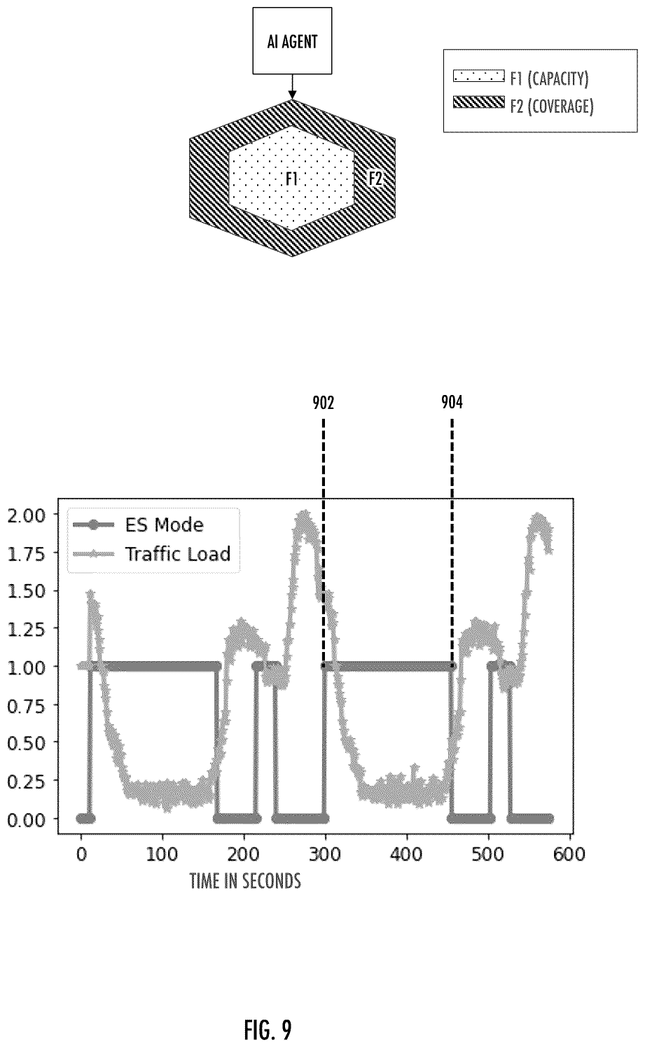

FIG. 9 is a graphical representation of energy saving operation, in accordance with one specific implementation of the present disclosure. As shown, a cell with a coverage layer (F2) can disable a capacity layer (F1) for energy saving (ES) operation; otherwise, the capacity layer may be enabled to handle traffic. In this example, current downlink physical resource block (DL PRB) utilization is used to predict future DL PRB utilization. As shown at time 902, the DRL agent predicts when the coverage layer is going to be underloaded, and responsively turns off the capacity layer (the ES mode transitions from o to 1). Similarly, at time 904 the DRL agent predicts when the coverage layer is going to be overloaded, and responsively turns on the capacity layer (the ES mode transitions from 1 to o).

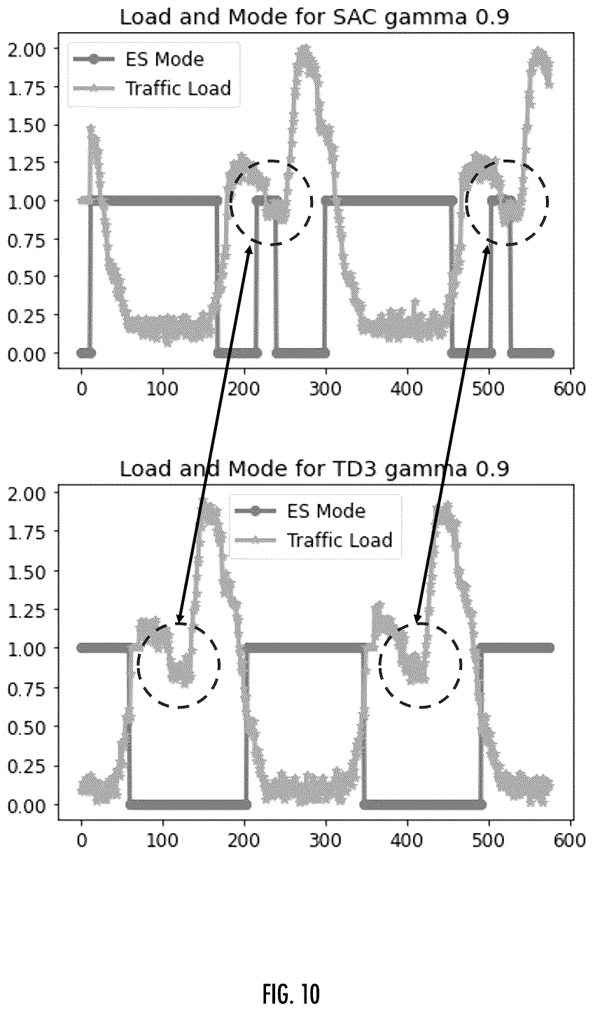

FIG. 10 is a graphical comparison of two different DRL agents. Empirically, a Soft Actor Critic (SAC) DRL provides slightly more aggressive power savings, compared to a Twin Delayed Deep Deterministic Policy Gradient (TD3). In other words, the SAC DRL enables ES mode even for relatively brief lulls of traffic (˜20 seconds). More generally, different DRL implementations may vary in their relative performance.

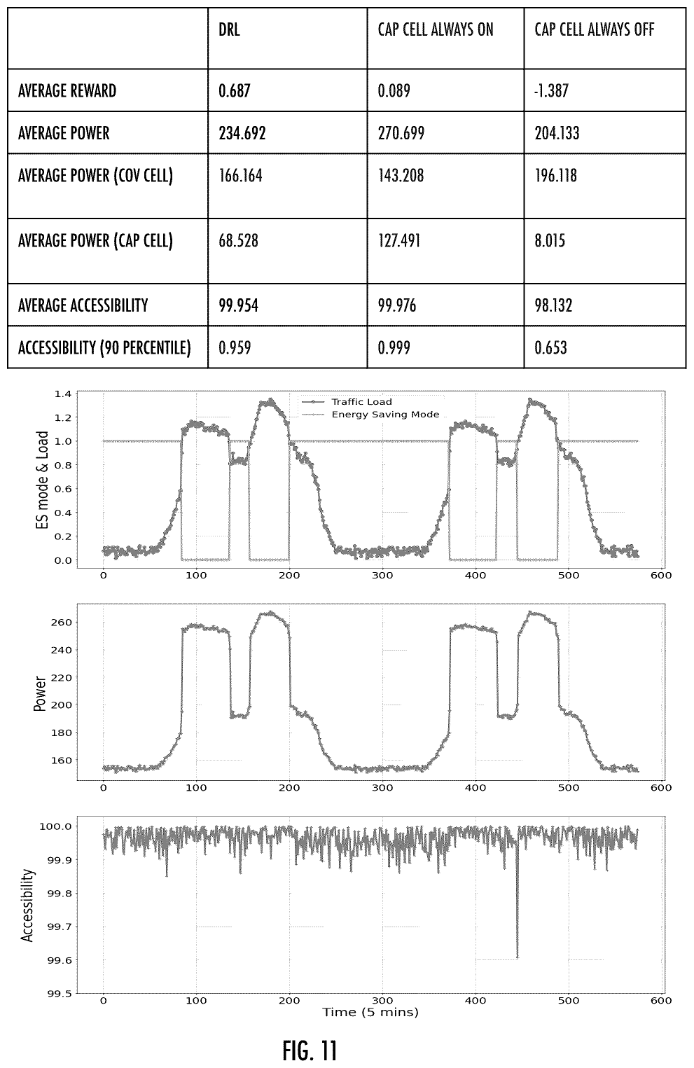

FIG. 11 provides a direct comparison of different operational modes. Here, the DRL agent controls ES mode in a first mode, the capacity cell is always on in a second mode, and the capacity cell is always off in a third mode. As shown, the first mode (DRL) provides substantial power savings over the second mode (always on) as indicated by the average power (234.692 compared to 270.699), yet the average accessibility remains quite high (99.954 compared to 99.976).

### Notable Variants and Modifications

While the foregoing techniques are discussed within the context of energy savings, the various techniques described throughout may be synergistically combined with other management and orchestration (MANO) functions. In some embodiments, these combinations may provide further Quality of Service (QOS) optimizations that further balance capacity against carrier energy consumption.

As but one example, turning cell state off cannot be done while User Equipment (UEs) are still attached; however, in some cases, there may not be enough UEs to justify higher energy consumption. In such cases, the DRL agent may trigger Mobile Load Balancing (MLB) to encourage handovers (thereby freeing the cell for sleep mode). Mobile Load Balancing (MLB) transfers users from an overloaded serving cell to underloaded neighboring cells by adjusting mobility parameters for the User Equipment. Conceptually, MLB incentivizes UEs at the edges of coverage to proactively transfer (handover) to other neighboring cells. In this way, network operators can significantly minimize energy consumption on underutilized frequency carriers. This may also work in the reverse direction as well; e.g., once a cell enables high-band operation, neighboring cells may adjust their mobility parameters to incentivize users to move to the higher capacity cell. These techniques are sometimes also referred to traffic steering. In this way, network operators can maximize bandwidth usage and thereby minimize the overall network energy consumption.

More broadly, the solutions described above may be extended to a variety of other MANO applications including, without limitation: application performance monitoring, service discovery, application service management, service orchestration, etc. For example, a performance monitoring application might determine that capacity layers must meet a minimum level of performance to justify continued usage-capacity layers may be culled when performance drops. As another example, service management may scale-up/scale-down layers based on ongoing cost considerations.

Additionally, while the foregoing examples prioritize capacity over power consumption, artisans of ordinary skill in the related arts will readily appreciate that other implementations may prefer power consumption over capacity. For example, one such implementation may enable mid-band capacity layers, but only enable high-band capacity layers during off-peak hours for power generation (thereby using less expensive energy). Still other implementations may offer mid-band and high-band capacity layers until a power usage has been reached, and then throttle service down.

### Generalized Network Architecture

A cellular network is a telecommunications network that uses a geographically distributed set of wireless coverage “cells” to provide a radio access network (RAN). User equipment can connect and transmit data to the cell; the data is routed from the originating cell to the core network. The core network may e.g., process the data and/or re-route the data to its destination, etc.

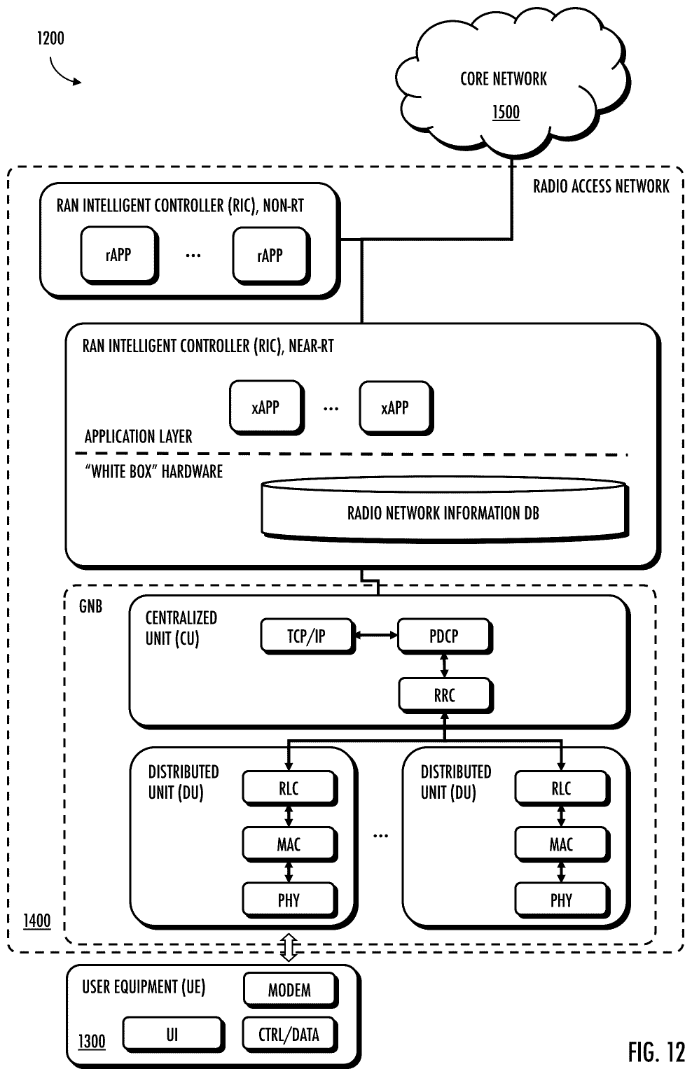

FIG. 12 is a logical block diagram of one generalized network architecture 1200, useful in accordance with the various principles described herein. The generalized network architecture 1200 may be functionally divided into: a plurality of user equipment 1300, a radio access network subsystem 1400, a core network subsystem 1500 which may include one or more externalized services, and interfaces to enable data transfer.

The following discussion provides a specific discussion of the internal operations, design considerations, and/or alternatives, for each subsystem of the generalized network architecture 1200.

### User Equipment

Functionally, the user equipment refers to any device used by a user (directly or on their behalf) to transact data with the radio access network (RAN). The illustrated user equipment includes: a radio network subsystem, a control and data subsystem, and a user interface subsystem. Examples of user equipment may include: cellular phones, computing device (laptops, personal computers, tablets, etc.), smart vehicles, smart appliances, and/or internet-of-things (IoT) and/or any other connected machines.

The radio network subsystem receives radio waves (in the “downlink”) and converts them into electrical signals, which are then demodulated into digital data. To transmit data, the radio network subsystem modulates digital data into electrical signals which can be transmitted (in the uplink) over the air as radio waves. Different radio access networks (RANs) use different radio access technologies (RATs).

The radio access technology for 5G utilizes a variety of advanced techniques to enable high-speed data transmission and low-latency communication. 5G employs technologies such as massive MIMO (Multiple Input Multiple Output), beamforming, and advanced modulation schemes like OFDM (Orthogonal Frequency Division Multiplexing) to deliver high data rates and improve spectral efficiency. Additionally, 5G introduces concepts like dynamic spectrum sharing (DSS) and network slicing to optimize resource allocation and support diverse use cases with varying requirements.

In the downlink path, a “physical resource block (PRB)” is a fundamental unit of radio resource allocation in 5G. It represents a specific amount of frequency and time resources within the network's overall bandwidth and time duration. In 5G, a PRB typically comprises a specific number of subcarriers in the frequency domain and a certain duration of symbols in the time domain. These subcarriers and symbols are allocated together to form a PRB, which can then be assigned to users for data transmission or other purposes.

Single Carrier Frequency Division Multiple Access (SC-FDMA) is used in the uplink path. The user equipment transmits its data on a single subcarrier within the allocated frequency band. SC-FDMA has a lower peak-to-average power ratio compared to OFDMA, making it more power-efficient for mobile devices. This is particularly advantageous in the uplink, where UE power consumption is a critical factor.

The user interface subsystem renders data for human use and/or obtains human input for the user equipment. For example, digital data may be rendered as images and/or reproduced as audio signals. Similarly, user actions (button presses, voice commands, touchscreen gestures, etc.) may be converted into digital data for manipulation and/or transmission. The user interface may include display screens, cameras, speakers, microphones, as well as physical input devices (e.g., buttons, mice, keyboards, joysticks, etc.).

The control and data subsystem obtains and manipulates digital data to perform various tasks. For example, a processor and memory (also referred to throughout as non-transitory computer-readable medium) may store programs as computer-readable instructions that when executed by the processor cause the processor to control the user interface subsystem, radio network subsystem, etc.

Within the context of the present disclosure, the user equipment may measure the radio link and report measurements to the radio access network (RAN). The RAN may then use this information as input for cell state activation. For example, in one exemplary embodiment, the UE may measure its downlink physical resource block (DL PRB) utilization. This information may be reported back to the RAN at regular intervals or when explicitly requested. As but one such example, downlink PRB utilization may be reported at every transmission time interval (TTI) which may be set as short as 125 microseconds or as long as 1 millisecond, etc. Notably, TTI intervals occur according to real-time scheduling of the downlink. Batches of TTI measurements may be reported to core network entities at non-real-time/best-effort scheduling (e.g., every minute, 5 minutes, 10 minutes, etc.).

As used herein, the term “real-time” refers to tasks that must be/were performed within definitive constraints; for example, a real-time UE measurement report corresponds to UE measurements at a specified time. Due to the highly variable nature of the radio environment, telecommunication networks operate under rigid timing constraints. UE measurement reports are often time sensitive and only reflect network conditions within a specific time window (frame, subframe, slot, etc.).

While the foregoing example is presented in the context of the physical resource blocks of an OFDM radio access technology, the concepts described throughout may be broadly extended to other radio access technologies. Examples of such technologies include e.g., time slots of time-division multiple access (TDMA), frequency bands of frequency-division multiple access (FDMA), codes of code-division multiple access (CDMA), and/or any of their variants and/or hybrids.

### Radio Access Network

Functionally, the radio access network refers to the collection of devices used by a network operator to control and moderate radio resources so as to enable data transactions with a plurality of user equipment. Examples of devices in the radio access network may include: base stations (macrocells, femtocells, picocells), access points, RF radio heads, servers, routers, and their associated networking and/or interfaces.

As a brief aside, 5G uses a protocol stack composed of different layers of protocols. Each layer of the protocol stack communicates with its logical counterpart in another device; for example, the Physical (PHY) layer of a gNB communicates with the PHY layer of the user equipment (UE), the Medium Access Control (MAC) layer of a GNB communicates with the MAC layer of the UE, etc. Each layer additionally provides a level of abstraction to the layer above it; for example, the PHY layer handles physical transmission functionality so that the MAC does not need to, etc. As shown, the 5G protocol stack is logically subdivided into: a Physical layer (PHY), a Medium Access Control layer (MAC), a Radio Link Control layer (RLC), a Packet Data Convergence Protocol layer (PDCP), a Radio Resource Connection layer (RRC), and a Transmission Control Protocol/Internet Protocol layer (TCP/IP).

The TCP/IP layer transact TCP/IP data packets to/from the Internet. The TCP/IP layer provides the data packets to the PDCP layer. The PDCP layer is responsible for compression and decompression of IP data, in-sequence (and de-duplicated) delivery of IP data, connection time-out, etc. Other PDCP functions may include ciphering and deciphering of data, integrity protection, integrity verification, and other higher layer security protocols. The PDCP layer relies on the RRC layer below it to establish and manage radio resources for a data connection (e.g., a radio bearer).

The RRC layer controls the radio connection. The RRC conveys System Information (SI) that is necessary for mobility management and/or IP connectivity. Additionally, radio bearers are established, maintained, and released via an RRC connection. Other RRC functionality may include key management, establishment, configuration, maintenance, and release of point-to-point radio bearers. The RRC layer relies on the RLC layer to manage data transfer over the radio bearer.

The RLC layer manages data transfer within logical channels of data. The RLC handles error correction, concatenation, segmentation, and reassembly of data according to the logical channels. In some cases, the RLC may also re-segment, reorder, detect duplicates, and/or discard data, etc. The RRC layer relies on the MAC layer to transport the logical channels of data.

The MAC layer maps logical channels to physical transport channels. This entails multiplexing logical channels onto transport blocks (TB) that can be delivered over the physical resources of the network. The MAC layer also manages error correction, dynamic scheduling, and logical channel prioritization. The MAC layer relies on the PHY layer to physically transmit the transport blocks over physical resources.

The PHY layer transfers information from transport channels over the air interface. The PHY layer handles link adaptation, power control, link synchronization, and physical measurements. 5G networks allow for flexible air interface configuration with a dynamic transmission time interval (TTI) and/or resource block assignments, etc. to achieve different radio link characteristics.

Referring back to FIG. 12, base stations are more commonly referred to as “gNodeBs” (gNBs) in 5G networks. The gNB typically subdivides the logical functionality of a base station into multiple different physical devices. Here, the gNB is split into centralized units (CUs), distributed units (DUs), and remote units (RUs).

The CU is responsible for data path/control path processing and network routing to provide access to intranets/Internet. A CU may include e.g. Radio Resource Connection (RRC) and Packet Data Convergence Protocol (PDCP) logic for both control and user plane data (PDCP-C, PDCP-U). The CU may be connected to the network operator's core network via an E2 interface.

DUs may be distributed within the coverage area to transact data with user equipment (UEs). Each DU includes the RF and baseband logic necessary to receive/transmit data over the physical link and generate digital data. A DU implementation may include logic for e.g., Physical layer (PHY), Medium Access Control (MAC), and Radio Link Control (RLC), and/or other layers of a protocol stack.

RUs may be used to augment the radio coverage of a DU. RUs typically only include PHY and/or very limited MAC/RLC functionality. RUs may also be coordinated by a DU to enable e.g., RF beamforming, precoding, and/or other antenna-specific functions.

In 5G, the gNBs are functionally controlled by a RAN Intelligent Controller (RIC) that facilitates the automation and optimization of the RAN. The RIC may be further subdivided into two distinct entities. A near-RT RIC handles time critical network services. Functionality that is based on system timing is time critical (e.g., transmission time intervals, subframes, time slots, etc.). For existing 5G networks, these functions tolerate less than 1 second of latency. Examples of near-RT functionality includes e.g., per-UE controlled load-balancing, resource block management, interference detection, interference mitigation, etc. In contrast, a non-RT RIC (non-real-time RIC) handles network functionality that is not time critical for network service. Examples of non-RT functionality may include e.g., service management, policy management, RAN analytics, model training for the near-RT RIC, etc. Non-real-time RIC operations occur at time frames larger than 1 second (e.g., multiple seconds, minutes, hours, etc.)

### Self-Organizing Network Variants

Self-Organizing Network (SON) technology is generally divided into the following functionalities: self-configuration, self-optimization, self-healing, and self-protection. Specifically, self-configuration allows new access nodes to be deployed within existing deployments using automatic network discovery, calibration, and/or configuration. Self-optimization requires that each access node dynamically controls its own operational parameters to maximize its own performance. Self-healing ensures that the overall network handles individual access node failures robustly. Self-protection prevents unauthorized access to the network.

5G networks that implement SON architectures may structure their RAN functionality differently. Feature-centric SONs subdivide RAN functionality across the network by feature. For example, RRC management for the entire network may be handled by an RRC management application, QoS management for the entire network may be handled by a QoS management application, etc. Cell-centric SONs divide RAN functionality according to cells of the network. For example, each cell has a SON agent that corresponds to a SON termination in a software instance of a cell optimization engine. Each cell optimization engine is responsible for controlling its cell's behavior, e.g., mobility management, QoS, etc. are handled by the cell optimization engine. Each SON termination/agent link is unique and allows for straightforward application access to CUS, DUs, RUs, etc.

Notably, the differences in RAN organization are used to prioritize real-time versus non-real-time tasks. In other words, feature-centric SONs are designed to prioritize network-wide features, cell-specific features may be cumbersome. Similarly, cell-centric SONs are designed to localize cell-specific operation to each cell's cell optimization engine; network-wide optimizations may be handled without time critical treatment.

As a practical matter, prioritization is necessary to enable operation within available commodity components; here, the term “commodity” refers to a goods and services that are fungible (interchangeable) with other goods/services of the same market segment. Commodity goods and services compete based on price, rather than brand recognition, functionality, power consumption, performance, or other differentiable features. Commodity pricing for capital expenditures (CAPEX) and operating expenses (OPEX) in the RAN are highly desirable for network operators; in general, its estimated that ˜70% of the total cost of ownership of the network is driven by RAN considerations.

As an important related consideration, incipient proposals for 5G (and future 6G) network infrastructure seek to use “Agile” and/or “DevOps” style feature roll-out. Agile network architectures add and/or modify services over incremental releases; DevOps refers to agile network architectures that additionally perform roll-out during live operations. As a practical matter, Agile and DevOps-capable network infrastructures must dynamically adapt to changes in the network architecture's services, structure (topology), traffic, and/or operation. More directly, network connectivity (and its corresponding market value) is often evaluated based on supported features, uptime, and reliability.

xApps and rApps in an “Open” Network Framework

Different use case scenarios may impose specific constraints and/or enable unique optimizations in RAN functionality (e.g., mobility management, inter-cell interference, etc.) 5G network operators have structurally addressed variability using a configurable “application layer” schema. Specifically, RAN functionality is subdivided into “applications” that are executed on “white box” hardware. So-called “white box” hardware accepts inputs and generates outputs but additionally allows an application to request visibility into and control of hardware of interest (so-called “black box” hardware accepts inputs and generates outputs without internal visibility).

Some 5G network operators have exposed the application layer schema to external vendors to provide 3^{rd} party network optimization services. Under this “open” framework, network automation applications are subdivided into “xApps” which are executed from the near-real-time RIC, and “rApps” which are executed at the non-real-time RIC. In other words, xApps and rApps allow external vendors to improve network operation, within the constraints of the application layer schema and white-box hardware visibility.

Various embodiments of the present disclosure are directed to an rApp running on the non-real-time RIC. The exemplary rApp obtains current usage statistics and predicts future usage statics. This information may be provided to the non-real-time RIC to advise cell activation state. More generally, the techniques described herein may be broadly extended to any non-real-time logic working in conjunction with, or on behalf of, the radio access network.

In one embodiment, the non-real-time logic obtains usage statistics for a first interval. In one specific implementation, the first interval may correspond to a duration that is representative of network traffic. For example, the first interval may correspond to minutes, hours, days, weeks, etc. of network activity. Average behavior over longer intervals may allow for better generalizations of characteristic network demand. Shorter intervals may be more susceptible to outlying behaviors, but may also reduce model training complexity, etc.

In one specific implementation, the usage statistics correspond to the physical resource block utilization of a specific cell during the first interval. More generally, any resource utilization metric that corresponds to network demand may be substituted with equal success. Examples may include e.g., total resource utilization, uplink resource utilization, downlink resource utilization, average throughput, average latency, utilization based interference, and/or any other measurement of traffic volume.

In one embodiment, the usage statistics are used to generate a predictive model. In one specific implementation, the predictive model is generated by training a machine-learning logic. Training may be performed according to a specific definition of network states, penalties/rewards, and actions. For example, network states might be defined by historic data on network traffic, resource utilization, and cell configuration (coverage, capacity, etc.). Reward might be defined according to a function that balances energy consumption and network performance. The resulting actions might be defined as a binary action (enable or disable energy saving mode, etc.). In some cases, the predictive model may be specific to the cell. In other cases, the predictive model may be generalized to a group of cells or even network-wide.

Once the predictive model is trained, the non-real-time logic may be used for predictive dynamic cell state management. During online mode, the non-real-time logic may obtain second usage statistics of the cell corresponding to a second time interval. The second time interval may correspond to a duration that is representative of current traffic demand, but which is batched and delivered at non-real-time/best-effort delivery (greater than 1 second of data). For example, the second interval may correspond to transmission time interval (TTI) data that is batched according to multiple seconds or a few minutes of network activity. Larger batches may not provide enough granularity to catch variations in traffic demand, however shorter intervals may be too frequent and/or result in unnecessary churn.

The predictive model uses the second usage statistics and the predictive model to predict the future usage statistics of the cell. In some cases, the future usage statistics may additionally have an associated prediction interval (e.g., next 5 minutes, next 10 minutes, next 15 minutes, etc.). In some cases, multiple future usage statistics may be used to estimate a confidence metric. Confidence metrics may be in the form of bounds (upper, lower), quartiles, and/or other statistical measures (mean, median, range, deviation, etc.).

In some cases, a prediction interval may be sub-divided into one or more portions. For example, consider a scenario where non-real-time reports are batched in increments of 1 hour. Providing advisories at 1 hour increments may not be sufficiently responsive to yield desired savings, thus the batched data may be used to provide advisories at smaller portions or reporting increments (e.g., once every 5 minutes, etc.).

The future usage statistics of the cell may be used to identify an operational mode of the cell. Here, the operational mode may be provided as an energy-saving mode and a capacity mode. While the foregoing example is provided in the context of a coverage and capacity cell, other implementations may e.g., suggest that more or less resources are enabled (e.g., changing the number of time slots, frequency bands, codes, etc.).

Once an operational mode is identified, the information may be provided to the near-real-time RIC as an advisory. For example, the rApp may provide the cell activation state as part of an advisory message for SON automation (e.g., near-real-time control via the E2 interface). In some cases, the advisory may include other metadata (e.g., prioritization, time stamps, confidence intervals, upper bound, lower bound, etc.). In some cases, the rAPP can directly change the state of a cell via the O1 interface (non-real-time).

Various embodiments of the present disclosure are directed to an xApp running on the near-real-time RIC. The exemplary xApp provides current usage statistics to an external network automation service. The external network automation service may provide advisory information. The advisory information may be checked against near-real-time considerations, and where acceptable, used to select the cell activation state. More generally, the techniques described herein may be broadly extended to any near-real-time logic working in conjunction with, or on behalf of, the radio access network.

In one embodiment, the xApp gathers usage statistics on a near-real-time basis. In some cases, the usage statistics may be directly calculated by a serving device (e.g., a base station, centralized unit, distributed unit, etc.). In other cases, the usage statistics may be requested and/or received from a client device (e.g., UE based measurement reports). For example, physical resource block utilization may be measured and/or received from the user equipment at transmission time intervals (TTIs) which occur multiple times within a second—this information may be reported back to the gNB of a cellular network.

In some embodiments, the usage statistics may be prepared for transmission to a non-real-time logic (e.g., an rApp, etc.). For example, multiple reporting real-time or near-real-time measurements may be batched for a duration that is representative of current traffic demand. In some cases, this may entail variable reporting e.g., the measurements may be batched in smaller increments during highly erratic demand and larger increments where demand is relatively stable.

In some cases, usage statistics may be combined with other “white box” information which is useful for network automation. Examples of operational information may include cell state configuration, power consumption, processing load, memory availability, and/or any other parameters affecting the RAN operation. Examples of demand information may include e.g., quality-of-service metrics, number of users, total throughput, signal-to-noise (SNR), interference, bit error rate (BER), block error rate (BLER), packet error rate (PER), packet retransmissions, etc.

In some embodiments, the usage statistics are provided to a non-real-time logic (e.g., an rApp, etc.). In some implementations, the usage statistics and/or other relevant information may be provided as a broadcast that is available to any application that is subscribed (e.g., subscription-based delivery). In other implementations, the batched statistics may be specifically delivered to an endpoint (point-to-point delivery).

Similarly, the near-real-time logic may obtain advisory operational mode for the cell from the non-real-time network management entity at a non-real-time basis. For example, the xApp may receive advisory messages that predict increasing or decreasing network traffic. In some cases, the advisory messages may include other information that may be useful to evaluate the context of the advisory. For example, time stamps may be used to determine whether the advisory information is timely (since it may be delivered via non-real-time/best-effort networks). As another example, confidence metrics may be used to gauge how aggressive/conservative the advisory information. Still other variants may include e.g. a prioritization and/or override information. As but one such example, some advisories may be prioritized due to other network considerations (network congestion, etc.), other advisories may be safely ignored.

The advisory information may be reviewed, and if suitable may be implemented. In one embodiment, the resulting selection may be provided back to the external service to provide feedback and/or assessment.

### Core Network and Externalized Services

Functionally, the core network refers to the collection of devices used by a network operator to administer and/or manage the network. Examples of core network functionality may include mobility management, session management, packet routing and forwarding, authentication, authorization, and accounting, etc. The following examples are purely illustrative of the breadth of functionalities enabled by the core network.

Mobility management ensures seamless connectivity as devices move between different geographical locations or network cells. This includes functions such as location tracking, handover management, and subscriber authentication.

Session management establishes and maintains communication sessions between mobile devices and external networks or services. This includes functions such as session setup, teardown, and quality of service (QOS) management to ensure the required level of performance for different types of traffic.

The core network routes and forwards packet data between user equipment and external networks, such as the internet or private corporate networks. This involves functions such as IP routing, packet inspection, and network address translation (NAT) to facilitate end-to-end communication.

The core network also authenticates users and authorizes their access to network resources and services. This involves verifying subscriber credentials, enforcing access policies, and providing secure authentication mechanisms to protect against unauthorized access. The core network collects usage data and generates billing records for mobile services consumed by subscribers. This may include functions such as call detail recording, charging policy enforcement, and integration with billing systems to facilitate accurate billing and revenue management.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for dynamically controlling a cell, comprising:
obtaining first usage statistics of the cell for a first interval;
generating a cell-specific predictive model based on the first usage statistics;
obtaining second usage statistics of the cell corresponding to a second time interval;
predicting third usage statistics of the cell for a third time interval, based on the second usage statistics and the cell-specific predictive model; and
selecting an operational mode of the cell for the third time interval based on the third usage statistics.

2. The method of claim 1, where the cell-specific predictive model comprises a plurality of predictive models trained to estimate a plurality of physical resource block utilizations for a corresponding plurality of different time intervals.

3. The method of claim 2, where the plurality of physical resource block utilizations comprise at least a first physical resource block utilization during a first portion of the third time interval and a second physical resource block utilization at a second portion of the third time interval.

4. The method of claim 3, further comprising determining an upper bound and a lower bound of the plurality of physical resource block utilizations for the third time interval based on the first portion and the second portion.

5. The method of claim 1, where the second usage statistics comprise real-time statistics and the method further comprises sending the operational mode to the cell via a non-real-time advisory message.

6. The method of claim 1, where the operational mode is selected from an energy-saving mode and a capacity mode.

7. The method of claim 1, where the cell-specific predictive model comprises a deep-reinforcement learning model trained to select the operational mode based on at least one of a network traffic, a resource utilization, and a previous operational mode.

8. A near-real-time radio access network controller, comprising:
a non-real-time network interface configured to transact non-real-time advisory messages with a non-real-time network management entity via a best-effort network;
a real-time control interface configured to control a cell according to a schedule constraint;
a processor; and
a non-transitory computer readable medium comprising instructions, which when executed by the processor, causes the near-real-time radio access network controller to:
obtain real-time usage statistics of the cell;
provide a first real-time usage statistic corresponding to a first time interval to the non-real-time network management entity;
obtain an advisory operational mode for the cell from the non-real-time network management entity, where the advisory operational mode corresponds to a second time interval subsequent to the first time interval; and
select a real-time operational mode of the cell based on the advisory operational mode.

9. The near-real-time radio access network controller of claim 8, where the real-time usage statistics of the cell comprise physical resource block utilization measured for each transmission time interval.

10. The near-real-time radio access network controller of claim 9, where the first real-time usage statistic corresponds to a first portion of the first time interval, and where the real-time usage statistics comprise a mean physical resource block utilization, a maximum physical resource block utilization, or a minimum physical resource block utilization.

11. The near-real-time radio access network controller of claim 8, where the instructions further cause the near-real-time radio access network controller to determine whether the advisory operational mode may be enabled according to the schedule constraint.

12. The near-real-time radio access network controller of claim 11, where the real-time operational mode is selected from an energy-saving mode and a capacity mode.

13. The near-real-time radio access network controller of claim 11, where the real-time control interface is further configured to control the cell according to a power consumption constraint and where the instructions further cause the near-real-time radio access network controller to determine whether the advisory operational mode may be enabled according to the power consumption constraint.

14. The near-real-time radio access network controller of claim 11, where the real-time control interface is further configured to control the cell according to a capacity hysteresis constraint and where the instructions further cause the near-real-time radio access network controller to determine whether the advisory operational mode may be enabled according to the capacity hysteresis constraint.

15. A non-real-time network management entity, comprising:
a non-real-time network interface configured to transact non-real-time advisory messages with a near-real-time radio access network controller via a best-effort network;
a processor; and
a non-transitory computer readable medium comprising instructions, which when executed by the processor, causes the non-real-time network management entity to:
obtain first cell-specific usage statistics of a cell corresponding to a first time interval, via a first non-real-time advisory message;
predict second cell-specific usage statistics of the cell for a second time interval, based on the first cell-specific usage statistics and a predictive model trained on historic real-time usage statistics that are specific to the cell;
select an operational mode of the cell for the second time interval based on the second cell-specific usage statistics; and
transmit the operational mode via a second non-real-time advisory message.

16. The non-real-time network management entity of claim 15, where the predictive model comprises a plurality of predictive models trained to estimate physical resource block utilization for a corresponding plurality of different time intervals.

17. The non-real-time network management entity of claim 16, where the second cell-specific usage statistics comprises at least a first physical resource block utilization during a first portion of the second time interval and a second physical resource block utilization at a second portion of the second time interval.

18. The non-real-time network management entity of claim 15, where the second cell-specific usage statistics comprise a quantile regression that characterizes a plurality of likelihoods for a corresponding plurality of future traffic loads.

19. The non-real-time network management entity of claim 15, where the second cell-specific usage statistics comprise a binary classification that characterizes whether a future traffic load exceeds a threshold.

20. The non-real-time network management entity of claim 15, where the instructions further cause the non-real-time network management entity to obtain an other cell-specific usage statistics of an other cell corresponding to the first time interval and where the second cell-specific usage statistics are based on the other cell-specific usage statistics.

21. The non-real-time network management entity of claim 15, where the instructions further cause the non-real-time network management entity to transmit the operational mode directly to a cell of the radio access network.
